(19) United States
(12) Patent Application Publication
(10) Pub. No.: US 2024/0175798 A1
(43) Pub. Date: May 30, 2024

(54) MICROSCOPIC IMAGING METHOD AND APPARATUS

(71) Applicant: CAMBRIDGE ENTERPRISE LIMITED, Cambridge, Cambridgeshire (GB)

(72) Inventors: Steven F. LEE, Cambridge Cambridgeshire (GB); Kevin O'HOLLERAN, Cambridge Cambridgeshire (GB); Alex COLLINS, Cambridge Cambridgeshire (GB)

(73) Assignee: CAMBRIDGE ENTERPRISE LIMITED, Cambridge, Cambridgeshire (GB)

(21) Appl. No.: 18/285,010

(22) PCT Filed: Mar. 29, 2022
(86) PCT No.: PCT/GB2022/050769

§ 371 Date: Sep. 29, 2023

(30) Foreign Application Priority Data
Mar. 30, 2021 (GB) 2104485.4

(51) Int. Cl. G01N 15/1434; G01N 15/149; G02B 21/00

(52) U.S. Cl. CPC G01N 15/1434; G01N 15/149; G02B 21/0032; G02B 21/006; G01N 2015/1445

(57) ABSTRACT

A microscopic imaging method comprising: illuminating a three-dimensional object with a light sheet generated by an illumination optical system and capturing light-field information of the illuminated object with an imaging optical system.

### TECHNICAL FIELD

The present invention relates to a microscopic imaging method and apparatus.

### BACKGROUND ART

Fast volumetric imaging is an increasingly important tool in many fields of biological and biomedical research. Traditional methods of 3D imaging, such as confocal or light-sheet microscopy, require the mechanical scanning of a sample to build a volume from multiple 0D points, or 1D or/2D measurements. This necessitates complex optical setups and results in slow acquisition times to image a 3D volume. The development of faster volumetric imaging methods has typically been focused on one of two outcomes—high-throughput or high temporal resolution.

High-throughput imaging enables the characterisation of large populations of cells, allowing meaningful statistics to be done using structural information. This can be achieved using microfluidics to flow cells through the field of view of the microscope. The movement of the sample is often used as an integral part of the imaging technique. As with all forms of imaging, a 2D representation of a 3D object has the potential to mislead.

It is an aim of the present invention to at least partially address some of the problems discussed above.

### SUMMARY OF THE INVENTION

According to a first aspect of the invention there is provided a microscopic imaging method for three-dimensional imaging of an object, comprising: flowing a three-dimensional object through a microfluidics channel such that the object position is varied relative to an imaging optical axis; illuminating the object with an illumination optical system as the object flows through the microfluidics channel; and capturing light-field information of the illuminated object with an imaging optical system as the object flows through the microfluidics channel.

Optionally, the illuminating of the three-dimensional object is performed with a light sheet generated by the illumination optical system.

According to a second aspect of the invention, there is provided a microscopic imaging method comprising: illuminating a three-dimensional object with a light sheet generated by an illumination optical system and capturing light-field information of the illuminated object with an imaging optical system.

Optionally, an optical axis of the light sheet extends in a direction having a substantial component parallel to an imaging optical axis. Optionally, the optical axis of the light sheet is parallel to the imaging optical axis. Alternatively, the optical axis of the light sheet is tilted with respect to the imaging optical axis.

Optionally, the light sheet illuminates a substantially planar portion of the object. Optionally, at least two different substantially planar portions of the object are illuminated and the respective light fields thereof imaged.

Optionally, the light sheet illuminates the entirety of the object. Optionally, at least two different objects are illuminated and the respective light fields thereof imaged.

Optionally, the at least two different portions of the object, or at least two different objects are illuminated by varying the relative position of the light sheet and the object or objects.

Optionally, the object position is varied relative to an imaging optical axis. Optionally, the object position is varied by flowing the object or objects through a microfluidics channel. Optionally, the microfluidics channel forms part of a flow cytometer.

Optionally, the illumination position is varied relative to an imaging optical axis. Optionally, the light illumination position is varied by scanning the light sheet across the object or objects.

Optionally, the illumination optical system comprises a laser light source.

Optionally, the captured light field is a Fourier light field.

Optionally, imaging optical system comprises a micro lens array arranged to focus images the illuminated object from different viewing angles.

Optionally, the micro lens array is arranged at a back focal plane of the imaging optical system.

Optionally, an effective numerical aperture of the micro lenses in the micro lens array provides a depth of field of the imaging optical system that is at least as deep as the object.

Optionally, imaginary lines connecting the centres of the adjacent micro lenses in the array form a grid and the micro lens array is arranged such no line of the grid is parallel to the light sheet, with respect to the plane orthogonal to the optical axis.

Optionally, the micro lens array is segmented by different coloured filters.

Optionally, the micro lens array has an order of symmetry of three or more.

Optionally, the smallest dimension of the object is 100 μm or less, optionally 10 μm or less.

Optionally, the imaging optical system has a magnification of at least 10×, optionally in the range of 20× to 100×.

Optionally, the method further comprises processing the captured light-field information to generate a three-dimensional image of the object.

Optionally, the processing comprises a first step of generating one or more three-dimensional images corresponding one or more different substantially planar portions of the object. Optionally, the processing further comprises a second step of combining a plurality of three-dimensional images corresponding to a plurality of substantially planar portions through the object to generate a composite three-dimensional image of the object.

Optionally, the method further comprises illuminating the three-dimensional object with one or more further light sheets generated by the illumination optical system and capturing light-field information of the object illuminated with the one or more further light sheets. Optionally, the light sheet and one or more further light sheets comprise different coloured light. Optionally, the light sheet and one or more further light sheets are translated or rotated relative each other so as to reduce overlap.

Optionally, the method generates 2D images with respect to the flow direction without motion blur by flowing cells at a sufficiently high rate that causes the light field to integrate the whole object along the flow axis.

Optionally, the illumination may be pulsed to minimise motion blur.

Optionally, the illumination may be pulsed multiple times within one exposure of an imaging device to create multiple 3D measurements in one exposure.

According to a third aspect of the invention, there is provided a method of flow cytometry, comprising imaging cells using the imaging method according to the first aspect, e.g. when the object position is varied relative to an imaging optical axis by flowing the object or objects through a microfluidics channel forming part of a flow cytometer.

According to a fourth aspect of the invention, there is provided a method of sorting cells, comprising imaging cells using the imaging method according to the first aspect, analysing the images to identify one or more characteristics of the cells, and sorting the cells according to said characteristics.

According to a fifth aspect of the invention, there is provided a microscopic imaging apparatus comprising: a microfluidics channel through which a three-dimensional object is configured to flow such that the object position is varied relative to an imaging optical axis; an illumination optical system configured to generate a light sheet and illuminate a three-dimensional object with said light sheet as the object flows through the microfluidics channel; and an imaging optical system configured to capture light-field information of the illuminated object as the object flows through the microfluidics channel.

According to a sixth aspect of the invention, there is provided a microscopic imaging apparatus comprising: an illumination optical system configured to generate a light sheet and illuminate a three-dimensional object with said light sheet; and an imaging optical system configured to capture light-field information of the illuminated object.

### BRIEF DESCRIPTION OF THE DRAWINGS

Further features and advantages of the invention are described below by way of non-limiting examples and with reference to the accompanying drawings in which:

FIG. 1 shows an example microscopic imaging apparatus;

FIG. 2 shows a static 15 μm diameter focal check microsphere being imaged by the microscope in (A) a wide light sheet configuration and (B) a narrow light sheet configuration;

FIG. 3 shows a cell flowing through a microfluidic channel, allowing light field images to be captured as the cell flows in a controlled manner;

FIG. 4 shows a cell in flow, (Left) raw lightfield image of a cell passing through the sheet, (Right) time montage of sequential images as two cells pass though the light sheet and are imaged at a single subaperture view, which shows snapshots of light field fluorescence images of a cell as it transits the light sheet in 10 ms;

FIG. 5 shows three orthogonal projections of a 3D reconstruction of two T cells flowing through the microscope, the orientation of the two cells is shown pictorially as an inset to guide the eye.

FIG. 6 shows an example image processing method.

### DETAILED DESCRIPTION

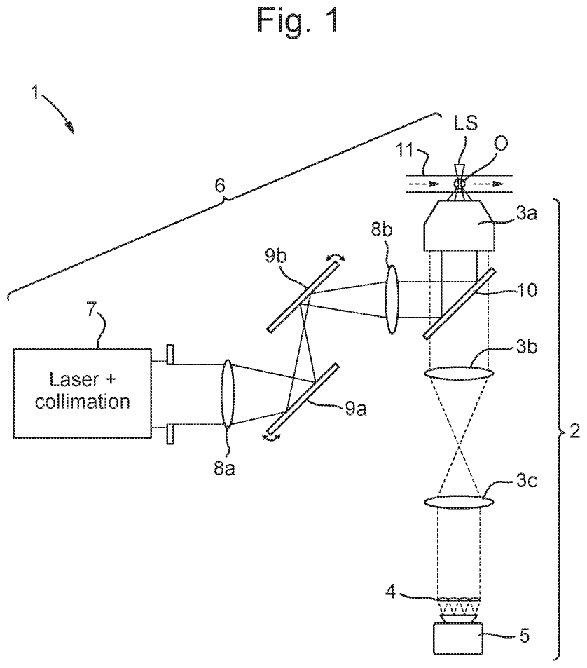

FIG. 1 schematically shows an example microscopic imaging apparatus 1 comprising an imaging optical system 2 and an illumination optical system 6.

As shown in FIG. 1, the imaging optical system 2 may comprise focusing optics 3a, 3b, 3c, a micro lens array 4 and an imaging device 5 (camera). The imaging optical system may also comprise an optical filter for filtering excitation wavelengths from emission wavelengths.

As shown in FIG. 1, the focusing optics may comprise a microscope objective 3a for gathering light from the object O and relay lenses 3b and 3c for relaying the back focal plane. It should be understood that in other examples the focusing optics 3 may comprise different optical elements. The purpose of the focusing optics 3 is to focus an (optionally, scaled) image.

As shown in FIG. 1, the micro lens array 4 may be arranged at or near the back focal plane of the imaging optical system 2. The purpose of the micro lens array 4 is to produce an array of images each corresponding to a perspective view the object O from a different viewing angle. The purpose of the imaging device 5 is to capture image data for the array of images. Such an imaging optical system 2, comprising a micro lens array 4, captures light-field information of the object. Preferably, the captured light field is a Fourier light field.

In some examples, an effective numerical aperture of the micro lenses in the micro lens array 4 may provide a depth of field of the imaging optical system 2 that is at least as deep as the object O. The effective numerical aperture may be defined as the proportion of the objective numerical aperture, back-projected from a micro lens focus to the object space.

A multiplicity of effective numerical aperture images, each translated in the back-focal-plane may improve reconstruction of the image.

Depth of field (DOF) is inversely proportional to numerical aperture (NA):

$$D O F \approx \frac{λ \sqrt{{n}^{2} - N {A}^{2}}}{2 N {A}^{2}}$$

where λ is the wavelength of emitted light, n is the refractive index of the medium between sample and microscope objective.

Extending the depth of field may require the loss of resolution—a smaller NA resulting in a larger diffraction limit. The effective NA (NA_{eff}) of the micro lenses is given by the NA of a micro lenses, NA_{MLA}, multiplied by the overall magnification of the system, which can be modified by changing the focal lengths of lenses leading to the micro lens array.

In practise, changing the DOF involves changing the diameter of the back focal plane by changing the system magnification (the diameter of a single micro lens being fixed for a given micro lens array) by using different combinations of lenses in the relay following the objective lens 3a of the imaging optical system 2.

As shown in FIG. 1. the illumination optical system 6 is configured to generate a light sheet LS. It is a portion of the three dimensional object space illuminated by the light sheet that is imaged by the imaging optical system 2.

The light-sheet LS may be formed by a substantially one-dimensional light beam, i.e. a light beam that forms a thin line of light. In other words the beam width may be substantially wider than the beam height. Although substantially planar, a light sheet LS has a finite width, albeit significantly smaller than the height and depth of the light sheet LS. Thus, the substantially planar light sheet LS may be a thin, three-dimensional, substantially sheet-shaped beam. The light sheet LS may be centred on a true plane in the optical axis. The width of the beam may change over the length of the imaging optical axis. The ratio of height to width may be at least 2, at least 4 or at least 10, for example. Sheet height and width may be determined by the FWHM of the beam in the orthogonal directions.

As shown in FIG. 1, the illumination optical system 6 may comprise a light source 7 and beam shaping optics, comprising lenses 8a and 8b and mirrors 9a and 9b. However, in other examples the beam shaping optics may comprise different optical elements.

As shown in FIG. 1, the light sheet LS may extend in a direction having a substantial component parallel to an imaging optical axis. As shown, the illumination optical axis and the imaging optical axis may be substantially parallel (at the object O), and optionally aligned with each other. In other words, the light sheet LS may extend substantially parallel to the imaging optical axis, and optionally aligned with it. However, strict parallelism is not required. The light sheet LS may be tilted relative to the imaging optical axis, in other examples. For example the light sheet may be tilted up to 45 degrees while still having a substantial component parallel to an imaging optical axis.

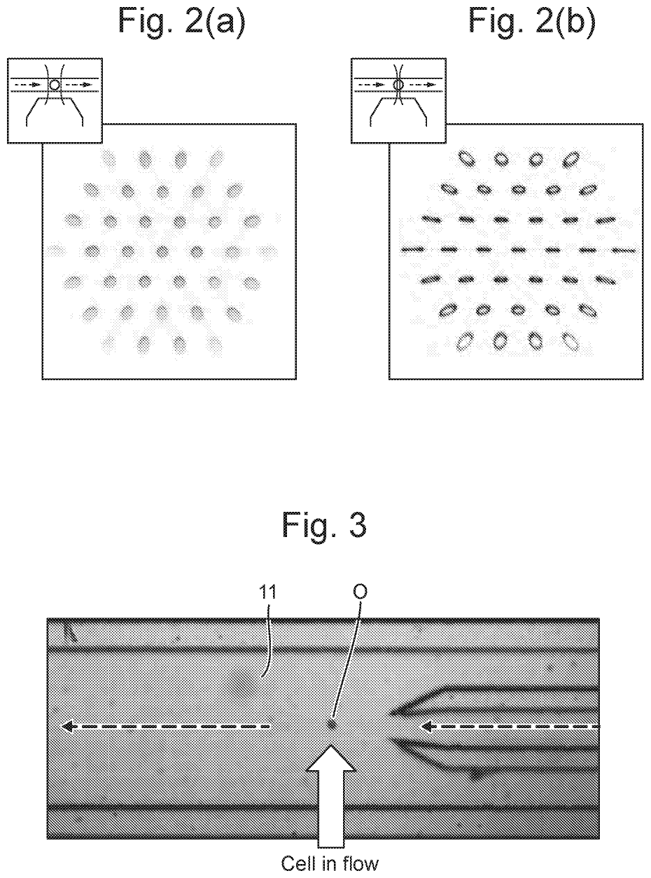

The light source 7 may be a laser light source. The beam shaping optics are configured to form the light sheet LS. As shown in FIG. 2, the light source 8 may emit a collimated beam. Alternatively, the beam shaping optics may collimate the light from the light source 7. As shown, a first cylindrical lens 8a may be arranged on the path of the collimated beam to focus the beam in one dimension to generate a line of light (in the height direction of the light sheet S). As shown, a second cylindrical lens 8b may be arranged downstream of the first cylindrical lens to re-collimate the line of light. Alternative optical arrangements may be possible that focus the beam in one axis perpendicular to the optical axis, to a greater degree than a second axis orthogonal to the first axis, to generate a line of light. Mirrors 9a and 9b may be used to bend the optical path to provide a more compact system.

The arrangement of the beam shaping optics may be used to set the width of the light sheet. The beam shaping optics may comprise optical elements that expand or concentrate the beam in the width direction of the light sheet LS. The beam shaping optics may be adjustable, e.g. the relative positions between two lenses, to set the width of the light sheet LS to a desired width. This tunability of light sheet width may allow imaging speeds to be varied. For example, imaging speeds can be faster if more of an object is captured by each image frame. However, increased imagining speed may be at the cost of spatial resolution or contrast.

As shown, the light sheet LS may pass through the microscope objective 3a to exit the illumination optical system 6 and the microscopic imaging apparatus 1. As shown the, light sheet LS may exit the microscope objective via a dielectric mirror 10 on the optical path of the imaging optical system 2. The dielectric mirror may reflect wavelengths of the illumination light toward the object O and transmit wavelengths emitted by the object O.

The light source 7 may be configured to emit light having a wavelength configured to excite molecules within the object O, which may in turn fluoresce. The light source 7 may emit light having a wavelength of less than 700 nm, and/or optionally greater than 400 nm, preferably in the range of 600 nm to 650 nm, e.g. around 638 nm.

The microscopic imaging system 1 may be configured to image an object O having a size of less than 100 μm, preferably in the range of 1 μm to 50 μm. For example, the object may have a size of around 15 μm. The object O may be a bacterial cell, a mammalian cell (e.g. human or animal cell) or cell aggregate such as organoid or spheriod. The imaging optical system 2 may have a magnification of at least 10×, preferably in the range of 20× to 100×, depending on the choice of detector pixel pitch and objective lens.

The small diameter—and therefore NA—of each micro lens in the micro lens array 4 limits its resolving power when considered individually. This is a necessary trade-off as the low NA of the micro lenses extends the depth of field. Preferably, micro lenses of the array 4 have a depth of field required to image the entire object O at once, i.e. of at least the depth of the object (e.g. 15 μm).

FIGS. 2A and 2B show two images capturing light-field information of a fluorescent spherical object illuminated with a light-sheet extending parallel to, and aligned with, the imaging optical axis. A hexagonally packed micro lens array was used, with 7 micro lenses spanning the back focal plane, thus producing 37 images from different viewing angles.

The two images, shown in FIGS. 2A and 2B differ in the width of the light sheet LS used, and therefore increased optical sectioning. As shown in the top left of each figure, FIG. 2A shows a case where the width of the light sheet LS is at least as wide as the width of the object O and FIG. 2B shows a case where the width of the light sheet LS is substantially less than the width of the object O. The width of the light sheet LS may be less than or equal to 50 μm. The light sheet LS may be from 2 μm to 30 μm (e.g. 20 μm) wide for certain applications, or less than 1 μm for other applications. The lower limit for light sheet width may be the diffraction limit of the laser source, or about 0.2-0.3 μm.

As is the case shown in FIG. 2A, the light sheet LS may be configured to illuminate the entirety of the object O. Thus different perspective views are generated of the entire object by the micro lenses.

As in the case shown in FIG. 2B, the light sheet LS may be configured to illuminate a substantially planar potion of the three-dimensional object O. The potion of the three-dimensional object O may correspond to a slice through the object, corresponding to the volume illuminated by the light sheet LS. Thus different perspective views are generated of each slice by the micro lenses.

At least two different substantially planar portions of the object O may be illuminated and the respective light fields thereof imaged. Different portions of the object O may be distinguished at least in part by being centred on different planes through the object O, though the portions themselves may overlap, due to the finite with of the light sheet LS.

Further, the at least two different potions of the object may be illuminated by varying the relative position of the illumination and the object O. For example, the object position may be varied relative to the imaging optical axis, and the illumination optical axis may be fixed relative to the imaging optical axis. In the same way, images of multiple objects may be captured.

As shown in FIGS. 1, 2A and 2B, the object position may be varied by flowing the object O (or objects) through a microfluidics channel 11. The microfluidics channel 11 may form part of a flow cytometer, for example. Accordingly, the imaging method disclosed herein may be part of a method of performing flow cytometry. A large number of object may be imaged continuously in this way.

FIG. 3 shows an example in which a single cell is flowed through a microfluidics channel 11 to be imaged. Preferably, the light sheet height and the viewing area imaged may span the width of the channel 11.

In alternative examples, the illumination position may be varied relative to an imaging optical axis instead. For example the illumination position may be varied by scanning illumination light across the object O. In other words, the illumination optical axis may be moved relative to the imaging optical axis.

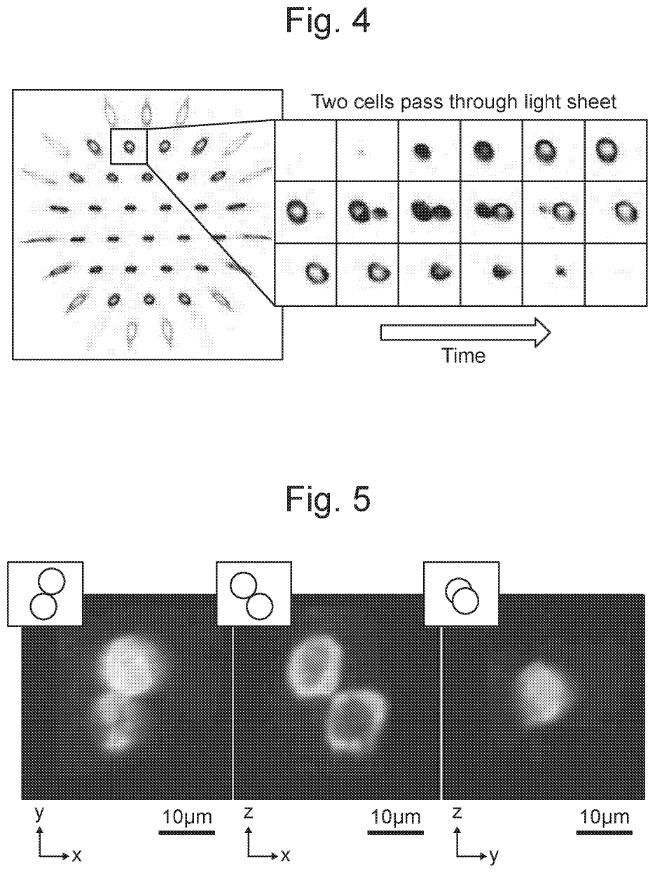

FIG. 4 shows images of an optically sectioned fluorescence image of cell, labelled with a dye the stains the plasma membrane. Different slices through the object O as the object O flows relative to the light sheet LS. The images on the right-hand side of FIG. 5 correspond to the same perspective view (i.e. the perspective boxed in the left hand of the Figure) with each subpanels representing images taken at different times as the cell moves through the LS. In this case, two cells flowed across the light sheet LS. By imaging at least two different slices of the object O, a three-dimensional image of the object may be constructed from images of the slices.

Whether imaging an entire object in one frame or multiple frames corresponding to difference slices through an object, the imaging method disclosed exploits the large collection angle of a high-NA objective with a micro lens array to produce an oblique perspective corresponding to a light sheet LS. Light emitted from the object O at high angles—i.e. at the edge of the cone of light captured by the objective—ends up at the outer edge of the back focal plane. The outer micro lenses therefore produce the most oblique perspectives—allowing the light sheet LS to be viewed from the side.

The captured light-field information may be processed to generate a three-dimensional image of the object O, or a portion of an object. The light sheet illumination provides a direct mapping from lateral coordinates in an image to axial coordinates of the object O, allowing reconstruction of the illuminated portion of the object O from one or more perspective views. FIG. 5 shows three orthogonal projections of a 3D reconstruction of two T cells captured according to the present imaging method. The orientation of the two cells is shown pictorially as an inset to guide the eye.

The off-axis perspectives given by different points in the back focal plane BFP, may substantially correspond to a skew transformation of the object O. The imaging optical system 2 may be orthographic, meaning that there may be substantially no parallax or change in apparent size with depth within a given view. In this case, the off-axis perspectives may substantially correspond to a pure skew transformation of the object O.

The amount of skew for a particular perspective view is dictated by the position of the respective micro lens in the back focal plane BFP. Micro lenses further from the centre view the object O from greater angles, which correspond to a greater level of skew. The change of wave front curvature with depth creates a mapping from lateral position to axial z-position. For a given point in the back focal plane there is a certain amount of lateral shift per unit shift in z.

The projection of the light sheet LS captured in a perspective view may be blurred by the finite (and varying) width of the light sheet LS. Based on the light sheet shape, the perspective view may be deconvolved to reconstruct the 3D volume illuminated by the light sheet LS. This may be performed by known imagine processing techniques.

The generation of 3D images may comprise full deconvolution (e.g. of a plurality or all the perspective views together) or local deconvolution (e.g. of each perspective view) with subsequent fusion of the individual deconvolved images. In one simple example, the deconvolution may comprise a simple deskewing and summing of perspective views.

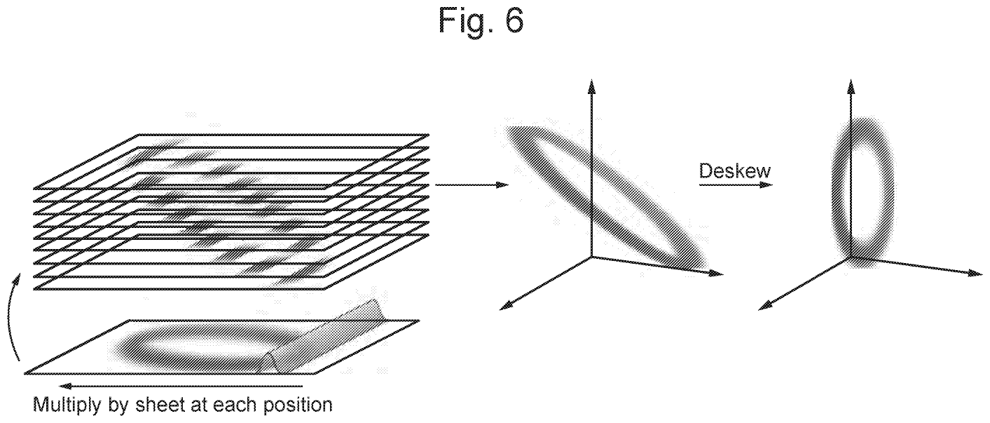

As illustrated by FIG. 6, an example processing method may comprise generating a plurality of partial images (top left in FIG. 6) corresponding to portions of a single perspective image (bottom left in FIG. 6). Each image portion corresponds to a different lateral position in the perspective image, i.e. axial position along the viewing axis of the single perspective image. Each image portion corresponds to a different axial (z-axis) position of the light sheet LS.

Each partial image may overlap with adjacent partial images. In other words, each pixel of the single perspective image may be represented in multiple partial images. A weighting function may be applied to achieve this. The weighting function may be a Gaussian corresponding to a profile of the light sheet LS. As shown in FIG. 6, the Gaussian profile may be ‘swept’ along the image in pixel steps (corresponding to different axial positions). The size of the steps may correspond to the skew value for the perspective image. The Gaussian profile may be updated at each step to account for variation in the sheet profile depending on axial position.

Prior knowledge of the light sheet LS profile may be used to apply a weighting to the intensity of each pixel. This may allow the reconstruction to take into account the uncertainty resulting from using a sheet of finite thickness. By including information about the sheet profile, more information about the object O can be extracted. This may require the sheet profile to be measured, e.g. by scanning a dye-coated coverslip in the z-direction.

As illustrated in FIG. 6, each of the images may be corrected for skew (de-skewed). That is to say, each of the plurality of partial images may be aligned with respect to the plane of the light sheet LS, (e.g. vertically). The partial images may then be combined to form a three-dimensional image. The three-dimensional image may be enhanced by combining it with three-dimensional images obtained from different other perspective views.

More than one perspective image may be used to re-construct a three-dimensional image corresponding to a slice through the object O. for example, these may be added or averaged. Alternatively, different perspective images may be compared to remove unwanted artefacts. Accordingly, the processing may comprise combining images of the object O, having different viewing angles.

The captured light-field information of images corresponding to slices through the object O may be processed to generate a three-dimensional image of the object O. The three-dimension image may correspond to a substantially three-dimensional portion of the object O or the entire object O, i.e. as opposed to a thin slice through the object O.

The processing method may comprise generating a plurality of three-dimensional images corresponding to different slices through the object O. Each of the three-dimensional images corresponding to slices through the object O may be generated by the methods described above. The plurality of three-dimensional images corresponding to slices through the object O may be combined to generate a composite three-dimensional image of the object O, e.g. that corresponds to a substantially three-dimensional portion of the object O or the entire object O.

The rate at which the object O moves relative to the light sheet LS, and a frame-rate of imaging device 5, define the spacing between the different substantially planar portions of the object O that are imaged. The preferred spacing may correspond to a spacing narrower than, or substantially equal to the finite waist thickness of the light sheet LS. A wider spacing may reduce the quality of a reconstructed image. However, a narrower spacing may not provide substantial improvement in the quality of a reconstructed image.

As described above, the light sheet LS illumination provides a direct mapping from lateral to axial coordinates—allowing reconstruction of the illuminated portion of the object O from a single perspective view. This may free up the other lenses in the array to be used for other things, such as the multiplexing of colour channels. Therefore, in some examples, the micro lens array may be segmented by different coloured filters.

If the number of micro lenses illuminated is increased, this increases the number of perspective views and thus the sampling density in the angular domain. If resolution of the reconstructed volume was to be prioritised, an increased number of perspectives would allow tomographic reconstruction of greater fidelity, or the more effective application of computational super-resolution methods.

As can be seen in FIG. 4, the lenses aligned with the long-axis of the light sheet LS provide limited 3D information when the light sheet is substantially thin. Their lateral shift with depth is confined to the plane of the sheet. As such, altering the light sheet LS and micro lens array 4 alignment may be advantageous to improve 3D reconstruction quality. While there is already redundancy in the number of micro lenses available—a single perspective is all that is needed for 3D reconstruction—it may still prove useful to maximise the number of useable lenses, especially looking forward to more intricate excitation geometries. The most straight forward way to achieve this would be to rotate the light sheet LS to minimise the number of lenses with perspectives coaxial with the light sheet, e.g. such that all the lenses provide out of plane perspectives.

Accordingly, lines connecting the centres of the adjacent micro lenses in the array 4 may form a grid and the micro lens array may be arranged such no line of the grid is parallel to the light sheet LS, with respect to the plane orthogonal to the imaging optical axis A.

For a multiplexed system in which the micro lens array 4 is segmented by different colour filters, multiple excitation sheets of different colours may be positioned at different angles. A micro lens array 4 of higher order of symmetry could also be used. Accordingly, the micro lens array may have an order of symmetry of three or more. This may make it easier to segment the micro lens array into three colours, and to find alignment so the light sheet LS that maximises the number of usable micro lenses.

In some examples, the 3D object may be illuminated additionally with one or more further light sheets. These may be generated by the illumination optical system also. In the same way as described above, the light-field information of the object illuminated with the one or more further light sheets may be captured. The light sheet and one or more further light sheets may comprise different coloured light. The imaging system may comprise corresponding imagining light paths and/or optical filters to capture the different coloured images. The light sheet and one or more further light sheets may be translated or rotated relative to each other so as to reduce, or eliminate, overlap between the light sheets.

One example application of the imaging method described above may be in a method of sorting cells (or other objects). Three-dimensional images of the cells may be analysed to identify one or more characteristics of the cells. The cells may then be sorting according to said characteristics. The image analysis and sorting may be performed using known techniques.

It should be understood that variations of the above examples may be made without departing from the spirit and scope of the present invention.

1. A microscopic imaging method for three-dimensional imaging of an object, comprising:
flowing a three-dimensional object through a microfluidics channel such that the object position is varied relative to an imaging optical axis;
illuminating the object with an illumination optical system as the object flows through the microfluidics channel; and
capturing light-field information of the illuminated object with an imaging optical system as the object flows through the microfluidics channel.

2. The method of claim 1, wherein the captured light field is a Fourier light field.

3. The method of claim 1 or 2, wherein imaging optical system comprises a micro lens array arranged to focus images the illuminated object from different viewing angles and the micro lens array is arranged at a back focal plane of the imaging optical system.

4. The method of any preceding claim, wherein the illuminating of the three-dimensional object is performed with a light sheet generated by the illumination optical system.

5. The method of claim 4, wherein an optical axis of the light sheet extends in a direction having a substantial component parallel to an imaging optical axis.

6. The method of claim 5, wherein the optical axis of the light sheet is parallel to the imaging optical axis.

7. The method of claim 5, wherein the optical axis of the light sheet is tilted with respect to the imaging optical axis.

8. The method of any one of claims 4 to 7, wherein the light sheet illuminates a substantially planar portion of the object.

9. The method of claim 8, wherein at least two different substantially planar portions of the object are illuminated and the respective light fields thereof imaged.

10. The method of any one of claims 4 to 7, wherein the light sheet illuminates the entirety of the object.

11. The method of claim 10, wherein at least two different objects are illuminated and the respective light fields thereof imaged.

12. The method of claim 9 or 11, wherein the at least two different portions of the object, or at least two different objects are illuminated by varying the relative position of the light sheet and the object or objects.

13. The method of claim 12, wherein the illumination position is varied relative to an imaging optical axis.

14. The method of claim 13, wherein the light illumination position is varied by scanning the light sheet across the object or objects.

15. The method of any preceding claim, wherein the illumination optical system comprises a laser light source.

16. The method of any preceding claim, wherein the microfluidics channel forms part of a flow cytometer.

17. The method of claim 3, wherein an effective numerical aperture of the micro lenses in the micro lens array provides a depth of field of the imaging optical system that is at least as deep as the object.

18. The method claim 4, when dependent on claim 3, wherein lines connecting the centres of the adjacent micro lenses in the array form a grid and the micro lens array is arranged such no line of the grid is parallel to the light sheet, with respect to the plane orthogonal to the optical axis.

19. The method of claim 3, 17 or 18, wherein the micro lens array is segmented by different coloured filters.

20. The method of claim 3 or 17 to 20, wherein the micro lens array has an order of symmetry of three or more.

21. The method of any preceding claim, wherein the smallest dimension of the object is 100 μm or less.

22. The method of any preceding claim, wherein the imaging optical system has a magnification of at least 10×, optionally in the range of 20× to 100×.

23. The method of any preceding claim, further comprising processing the captured light-field information to generate a three-dimensional image of the object.

24. The method of claim 23, comprising a first step of generating one or more three-dimensional images corresponding one or more different substantially planar portions of the object.

25. The method of claim 24, further comprising a second step of combining a plurality of three-dimensional images corresponding to a plurality of substantially planar portions through the object to generate a composite three-dimensional image of the object.

26. The method of any preceding claim, further comprising illuminating the three-dimensional object with one or more further light sheets generated by the illumination optical system and capturing light-field information of the object illuminated with the one or more further light sheets.

27. The method of claim 26, wherein the light sheet and one or more further light sheets comprise different coloured light.

28. The method of claim 26 or 27, wherein the light sheet and one or more further light sheets are translated or rotated relative each other so as to reduce overlap.

29. A microscopic imaging apparatus comprising:
a microfluidics channel through which a three-dimensional object is configured to flow such that the object position is varied relative to an imaging optical axis;
an illumination optical system configured to illuminate a three-dimensional object as the object flows through the microfluidics channel; and
an imaging optical system configured to capture light-field information of the illuminated object as the object flows through the microfluidics channel.

30. A microscopic imaging method comprising:
illuminating a three-dimensional object with a light sheet generated by an illumination optical system; and
capturing light-field information of the illuminated object with an imaging optical system.

31. The method of claim 30, wherein the captured light field is a Fourier light field.

32. The method of claim 30 or 32, wherein imaging optical system comprises a micro lens array arranged to focus images the illuminated object from different viewing angles and the micro lens array is arranged at a back focal plane of the imaging optical system.

33. The method of any one of claims 30 to 32, wherein the object position is varied relative to an imaging optical axis.

34. The method of claim 33, wherein the object position is varied by flowing the object through a microfluidics channel.

35. The method of claim 33 or 34, wherein the at least two different portions of the object, or at least two different objects are illuminated and the light-fields thereof captured by varying the relative position of the light sheet and the object or objects.

36. A microscopic imaging apparatus comprising:
an illumination optical system configured to generate a light sheet and illuminate a three-dimensional object with said light sheet; and
an imaging optical system configured to capture light-field information of the illuminated object.

37. A method of flow cytometry, comprising imaging cells using the imaging method according to any one of claims 1 to 28 and 30 to 35.

38. A method of sorting cells, comprising imaging cells using the imaging method according to any one of claims 1 to 28 and 30 to 35, analysing the images to identify one or more characteristics of the cells, and sorting the cells according to said characteristics.
